(19) United States
(12) Patent Application Publication
(10) Pub. No.: US 2025/0376888 A1
(43) Pub. Date: Dec. 11, 2025

(54) GUN SAFE

(71) Applicant: American Tactical, Inc., Summerville, SC (US)

(72) Inventor: Anthony DiChario, Eutawville, SC (US)

(73) Assignee: American Tactical, Inc., Summerville, SC (US)

(21) Appl. No.: 19/233,168

(22) Filed: Jun. 10, 2025

Related U.S. Application Data
(60) Provisional application No. 63/658,246, filed on Jun. 10, 2024.

(51) Int. Cl. E05G 1/026; A47B 81/00; E05D 7/00; E05D 7/14; E05G 1/024

(52) U.S. Cl. CPC E05G 1/026; A47B 81/005; E05D 7/009; E05D 7/14; E05G 1/024

(57) ABSTRACT

The present invention is directed to a secure enclosure. The secure enclosure includes a housing, a housing door coupled to the housing and moveable between an opened position and a closed position, the housing door including a concealment panel coupled to an innermost face of the housing door and a storage cavity concealed from view by the concealment panel, and a door locking system mounted to the housing door within the storage cavity and configured to selectively lock the housing door to and unlock the housing door from the housing while in the closed position.

### TECHNICAL FIELD

The present invention relates to the field of lockable enclosures and more particularly relates to a concealed storage compartment within the door of a gun safe. This application claims the benefit of U.S. Provisional Patent Application No. 63/658,246, filed Jun. 10, 2024, the entireties of which are included herein by reference.

### BACKGROUND OF THE INVENTION

Secured enclosures (e.g., home safes or a gun safe) have become popular as a way of protecting valuables and preventing firearms from inadvertent discharge or handling by those who are not authorized to have access to them.

One aspect of many gun safes is that they are large and conspicuous, thereby signaling that objects of value may be stored within. Conventional gun safes are generally box-shaped and include a lockable, outwardly swinging door for access to the interior of the safe. The interior of a gun safe typically includes a combination of racks for supporting one or more rows of guns in a generally upright position and shelves for storing valuables and firearm accessories.

Another aspect of a gun safe is that the size and weight of the door may result in the door being opened and closed slowly and may require the door to be opened wide to access certain contents stored within. This aspect of gun safes may provide unintended parties an opportunity to view valuables and firearms stored within.

Accordingly, there exists a need for a gun safe that addresses the aforementioned drawbacks and deficiencies.

### SUMMARY OF THE INVENTION

The present invention addresses the above-noted needs of the prior art. In an embodiment, the secure enclosure includes a housing, a housing door coupled to the housing and moveable between an opened position and a closed position, and a door locking system mounted to the housing door. The housing door includes a concealment panel coupled to an innermost face of the housing door and a storage cavity concealed from view by the concealment panel. The door locking system is mounted within the storage cavity of the housing door and configured to selectively lock the housing door to, and unlock the housing door from, the housing while in the closed position.

### BRIEF DESCRIPTION OF THE DRAWINGS

The invention is herein described, by way of example only, with reference to the accompanying drawings, wherein:

FIG. 1 is a perspective view of an exemplary gun safe with the main door in a closed position in accordance with an aspect of the present invention;

FIG. 2 is a perspective view of a door of an exemplary gun safe with a concealed hidden compartment in accordance with an aspect of the present invention;

FIG. 3 is a perspective view of a door of an exemplary gun safe with an exposed hidden compartment in accordance with an aspect of the present invention.

FIG. 4A is a side elevational view of an embodiment of the invention with the compartment door open;

FIG. 4B is a front elevational view of an embodiment of the invention with a concealment panel open;

FIG. 5 is a perspective view of the door of FIG. 4 with the concealment panel partially open in accordance with an embodiment of the invention;

FIG. 6 is a top plan view of a door of FIG. 4 in accordance with an embodiment of the invention; and

FIGS. 7A-7B illustrate exemplary embodiments of catches and latches used to detachably couple a concealment panel in a closed position in accordance with embodiments of the invention.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

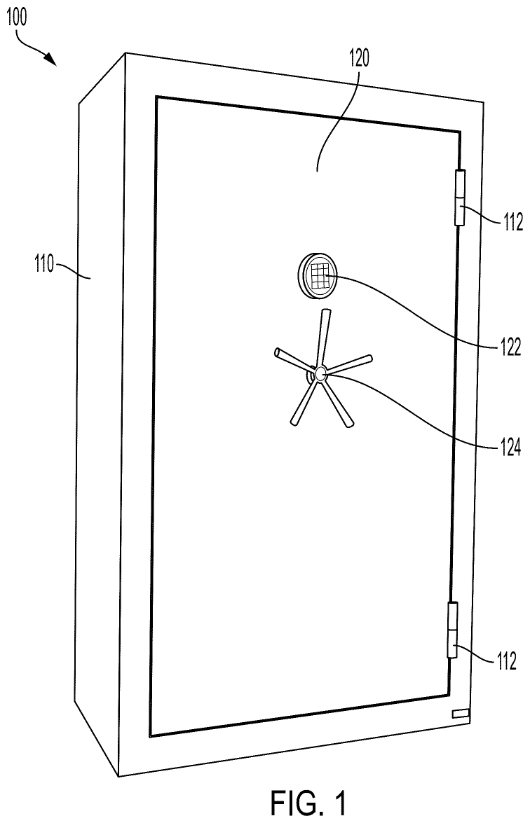

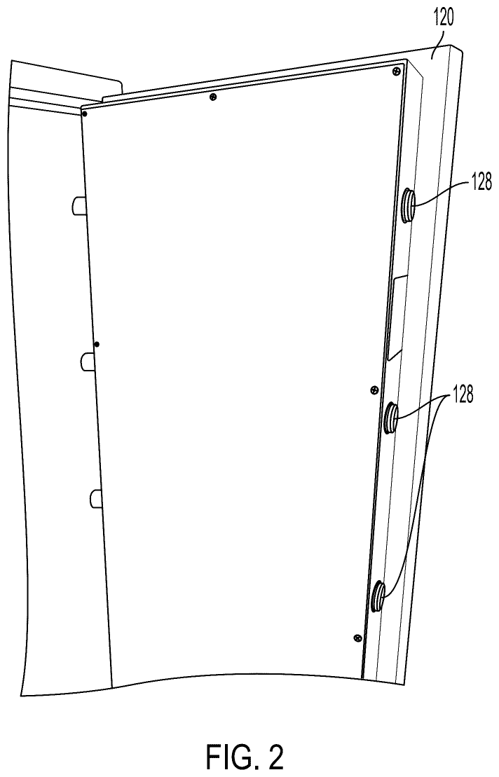

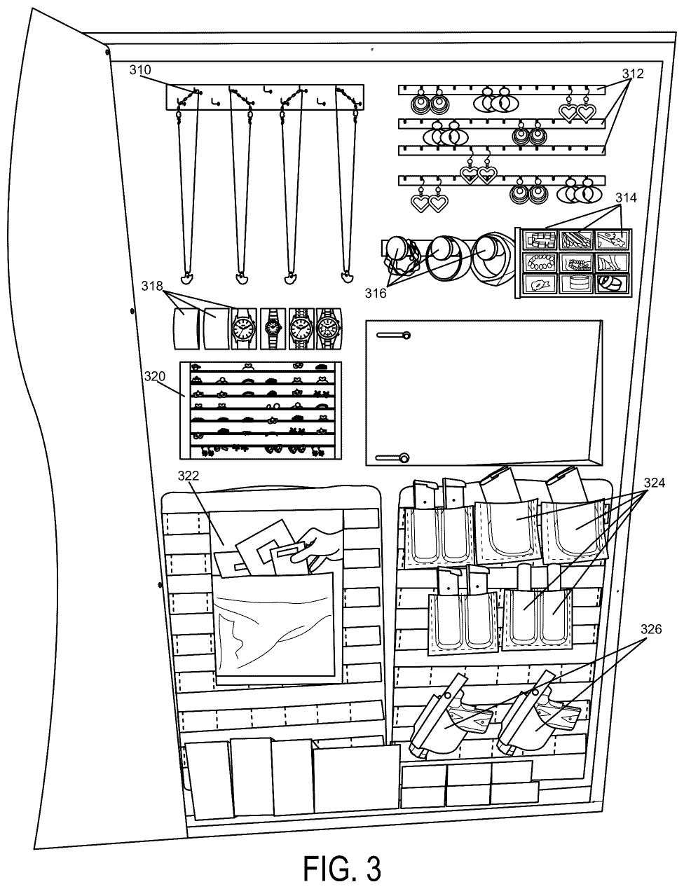

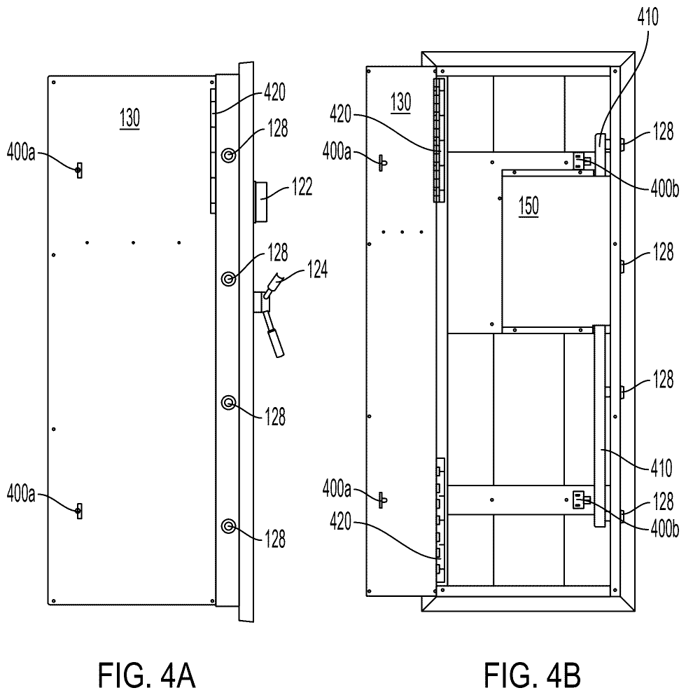

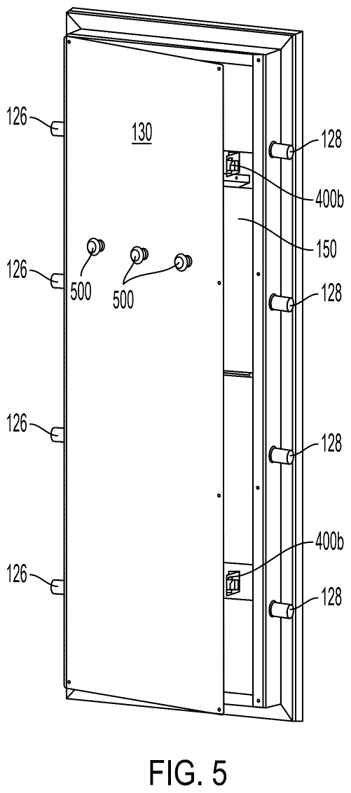

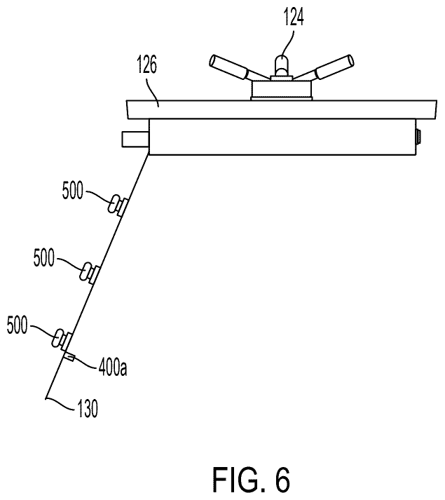

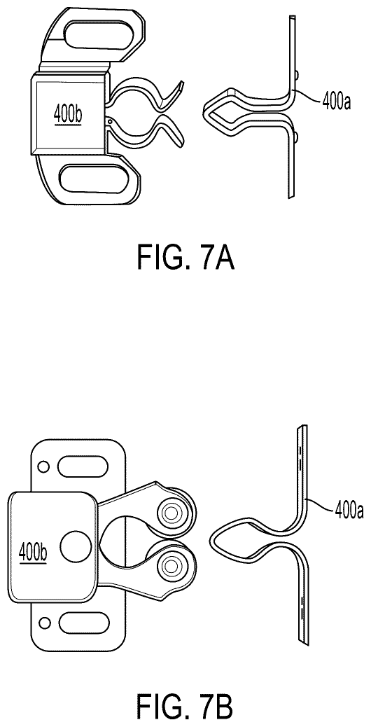

FIGS. 1-3 illustrate an exemplary gun safe in accordance with aspects of the present invention. FIGS. 4A-7B illustrate various aspects of a housing door of an exemplary gun safe in accordance with aspects of the present invention. Referring to FIG. 1-3, a secure enclosure 100 (e.g., a gun safe) is provided. The secure enclosure 100 may include a housing 110, a housing door 120, a concealment panel 130, a storage cavity 140, and an access panel 150 providing access to a door locking system including a lock 122 and a handle 124.

In embodiments of the present invention, the housing door 120 is coupled to the housing 110 and movable between an open position and a closed position. For example, in certain embodiments the housing door 120 may be coupled to the housing 110 via one or more hinges 112. In certain embodiments the hinges may include non-removable pins. The housing door 120 may include the concealment panel 130 coupled to an innermost face of the housing door 120 and the storage cavity 140 concealed from view by the concealment panel 130. The storage cavity 140 of the housing door 120 is configured to hold important and/or valuable personal items and may include one or more organizers specific to the contents being stored therein. For example, the storage cavity 140 may include hooks 310 for holding necklaces, notches 312 for holding earrings, drawers 314 for holding small accessories (e.g., broaches, tie tacks, tie clips, hair pins, etc.), post hangers 316 for holding bracelets, cushions 318 for holding watches, grooves 320 for holding rings, sleeves, pockets, or folders 322 for holding documents, holsters for holding firearms and firearm accessories (e.g., magazine holsters 324 and pistol holsters 326), and the like in a space defined between the housing door and the concealment panel. That is, the storage cavity 140 may include shelves, panels, rods, hooks, drawers, notches, slots, grooves, recesses, bags, holders, holsters, or the like configured to secure firearms, firearm accessories (e.g., magazines, optics, lights, ammunition), documents, money, jewelry, watches, or any other comparably sized object deemed valuable by the owner. The one or more organizers may be fixed, removable, or a combination thereof.

In certain embodiments, the housing door 120 may comprise an outermost steel layer, at least one fire-resistant layer, a steel inner liner layer, and the concealment panel 130. Further, in certain embodiments, the storage cavity 140 may be formed between a steel inner liner layer and the concealment panel 130. The concealment panel 130 may be pivotally coupled to the housing door 120 along a first edge of the concealment panel 130. For example, the concealment panel 130 may be coupled to the housing door 120 via one or more plano hinges 420, concealed hinge, or any other suitable means along an edge of the concealment panel 130 proximate to the one or more hinges coupling the housing door 120 to the housing 110. The opening edge of the concealment panel 130, on the opposite edge from the hinge, may protrude a distance that is just sufficient for a user to pull the door open but disguises the openable nature of the concealment panel 130 without interfering with movement of the housing door 120. The nature of concealment panel 130 may further be disguised by maintaining the aesthetic, borders and spacing of the other edges of the concealment panel.

In certain embodiments, the nature of concealment panel 130 may further be disguised by the inclusion of one or more hooks or knobs 500 disposed on a side of concealment panel 130 opposite the storage cavity 140. The hooks or knobs 500 may function as a holder for certain contents (e.g., a watch or a bracelet) and provide additional grip, acting as a handle, for opening concealment panel 130. In certain embodiments, there may be a plurality of hooks or knobs 500. In other embodiments, a single hook or knob 500 may be used. In some embodiments, the hooks or knobs 500 may be evenly spaced horizontally across the width of the concealment panel 130. In other embodiments, the hooks or knobs 500 may be asymmetrically disposed across the width of the concealment panel 130. In some embodiments, the hooks or knobs 500 may be disposed in a single line across the width of the concealment panel 130. In other embodiments, the hooks or knobs 500 may be in two or more lines across the width of the concealment panel 130.

In some embodiments, the concealment panel 130 may be detachably coupled to the housing door 120 along a second edge of the concealment panel opposite the first edge. For example, the concealment panel 130 may be detachably coupled to the housing door 120 via catches 400b, latches 400a, fasteners, or any other suitable coupling (e.g., a magnetic catch and latch, a roller catch and latch, a friction catch and latch, a hook and loop fastener, etc.). In certain embodiments, the catches 400b may be mounted to a metal tab extending into the storage cavity 140.

In certain embodiments, the concealment panel 130 may remain proximate to an inner face of the housing door 120 along the second edge (i.e., the opening edge) opposite the first edge (i.e., the hinged edge) based on friction within the plano hinge 420, a spring bias within the plano hinge 420, or friction between the concealment panel 130 and the storage cavity 140.

In some embodiments, the concealment panel 130 may include faux screws 132 to further disguise the concealment panel 130. The nature of concealment panel 130 may further be disguised by uniform fit and finish at the interface with the housing door 120.

The secure enclosure 100 may further include a door locking system, a portion of which is protected by access panel 150 mounted to the housing door 120 within the storage cavity 140. The door locking system may include a lock 122, a handle 124, boltworks (not shown), a bolt bar 410 and bolts 126, 128. A portion of the bolts (e.g., bolts 126) may be passive bolts and a portion of the bolts (e.g., bolts 128) may be active bolts. In certain embodiments, bolts 126 and bolts 128 may be active bolts.

The door locking system may be configured to selectively lock the housing door 120 to and unlock the housing door 120 from the housing 110 while in the closed position. The lock 122 and the handle 124 may be coupled to at least a portion of the bolts 126, 128 via a bolt bar 410 and boltworks (not shown). For example, unlocking lock 122 may enable the handle 124 to turn. When the handle 124 turns, the lockworks are actuated to move the bolt bar 410 to simultaneously deploy or retract active bolts (e.g., bolts 128) mounted in the housing door 120 within the storage cavity 140. In some embodiments the bolt bar 410 may be a single piece, while other embodiments may include a two piece bolt bar 410. Further, in certain embodiments, the boltwork mechanism may be a 2-way, 3-way, or 4-way boltwork actively securing 2 sides, 3 sides, or 4 sides of the housing door 120 to the housing 110.

In certain embodiments the lock 122 may be a combination lock, a key lock, a digital lock, a biometric lock, or a combination thereof. In an exemplary embodiment, the lock 122 is a digital lock.

In embodiments of the present invention, the handle 124 may be a spoke handle, a lever, or any other suitable handle configured to be rotated to actuate retraction and extension of the bolts. In an exemplary embodiment, the handle 124 may be a three-spoke handle.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A secure enclosure comprising:
a housing;
a housing door coupled to the housing and movable between an opened position and a closed position, wherein the housing door comprises a concealment panel coupled to an innermost face of the housing door and a storage cavity concealed from view by the concealment panel; and
a door locking system mounted to the housing door within the storage cavity and configured to selectively lock the housing door to and unlock the housing door from the housing while in the closed position.

2. The secure enclosure of claim 1, wherein the secure enclosure is a gun safe, and
wherein the storage cavity of the housing door is configured to store at least one of jewelry, documents, one or more firearms, or firearm accessories between an outermost face of the housing door and the concealment panel.

3. The secure enclosure of claim 1, wherein the housing door comprises an outermost steel layer, a fire-resistant layer, a steel inner liner layer, and the concealment panel.

4. The secure enclosure of claim 3, wherein the storage cavity is formed between the steel inner liner layer and the concealment panel.

5. The secure enclosure of claim 1, wherein the concealment panel is pivotally coupled to the housing door along a first edge of the concealment panel.

6. The secure enclosure of claim 5, wherein the concealment panel is pivotally coupled to the housing door along the first edge of the concealment panel via a plano hinge.

7. The secure enclosure of claim 5, wherein the concealment panel is detachably coupled to the housing door along a second edge of the concealment panel opposite the first edge.

8. The secure enclosure of claim 7, wherein the concealment panel is detachably coupled to the housing door using at least one of a catch, a latch, a magnet, or a fastener.
